(19) United States
(12) Patent Application Publication
(10) Pub. No.: US 2025/0285224 A1
(43) Pub. Date: Sep. 11, 2025

(54) Image processing apparatus and method having storage resource saving mechanism

(71) Applicant: REALTEK SEMICONDUCTOR CORPORATION, HSINCHU (TW)

(72) Inventors: JIA-WEI WU, HSINCHU (TW); CHIN-TIEN LU, HSINCHU (TW); YU-AN CHANG, HSINCHU (TW); KUO-CHIH PENG, HSINCHU (TW)

(21) Appl. No.: 19/059,684

(22) Filed: Feb. 21, 2025

(30) Foreign Application Priority Data
Mar. 11, 2024 (TW) 113108777

(51) Int. Cl. G06T 3/60; G06T 1/60; G06T 5/20

(52) U.S. Cl. CPC G06T 3/60; G06T 1/60; G06T 5/20

(57) ABSTRACT

The present disclosure discloses an image processing method having storage resource saving mechanism including steps outlined below. An original image frame is stored in a frame storage circuit and is read column-by-column to an operation storage circuit. The original image frame is rotated along a rotation direction for 90 degrees to generate a first rotated image frame. A first row direction image operation is performed row-by-row to generate a first operated image frame to be stored in the operation storage circuit. The first operated image frame is rotated along the rotation direction for 270 degrees to generate a second rotated image frame. The second rotated image frame is stored in the frame storage circuit. The second rotated image frame is read column-by-column to the operation storage circuit. A second row direction image operation is performed row-by-row to generate a second operated image frame. The second operated image frame is outputted.

### BACKGROUND OF THE INVENTION

### 1. Field of the Invention

The present disclosure relates to an image processing apparatus and an image processing apparatus method having a storage resource saving mechanism.

### 2. Description of Related Art

In the field of image processing, algorithms of such as debanding or filtering may perform operation on the pixels in a range of a cross pattern. More specifically, taking any one of the pixels in an image serving as a center as an example, the horizontal pixels on the left side and the right side around the center and the vertical pixels on the up side and the down side around the center are taken into consideration to perform operation thereon.

However in the design of the current image processing circuit, the pixels in the image are fed in a row-by-row manner. When the operation of the algorithms described above is performed, the vertical pixels need to be accessed by using the static random-access memory (SRAM) in the form of line buffers. The result of the operation of the algorithms described above is closed related to the number of the pixels taken into consideration and requires a large number of pixels to accomplish a better result. However, a large amount of pixels on the vertical direction requires a lot of line buffers to store the data thereof such that the circuit cost increases.

### SUMMARY OF THE INVENTION

In consideration of the problem of the prior art, an object of the present disclosure is to provide an image processing apparatus and an image processing apparatus method having a storage resource saving mechanism.

The present invention discloses an image processing method having a storage resource saving mechanism that includes steps outlined below. An original image frame is stored in a frame storage circuit. The original image frame is read column-by-column to an operation storage circuit. The original image frame is rotated along a rotation direction for 90 degrees to generate a first rotated image frame. A first row direction image operation is performed on the first rotated image frame row-by-row to generate a first operated image frame to be stored in the operation storage circuit. The first operated image frame is rotated along the rotation direction for 270 degrees to generate a second rotated image frame. The second rotated image frame is stored in the frame storage circuit. The second rotated image frame is read row-by-row to the operation storage circuit. A second row direction image operation is performed on the second rotated image frame row-by-row to generate a second operated image frame. The second operated image frame is outputted.

The present invention also discloses an image processing apparatus having a storage resource saving mechanism that includes a frame storage circuit, an operation storage circuit and a processing circuit. The processing circuit is electrically coupled to the frame storage circuit and the operation storage circuit and is configured to execute an image processing method that includes steps outlined below. An original image frame is stored in the frame storage circuit. The original image frame is read column-by-column to the operation storage circuit. The original image frame is rotated along a rotation direction for 90 degrees to generate a first rotated image frame. A first row direction image operation is performed on the first rotated image frame row-by-row to generate a first operated image frame to be stored in the operation storage circuit. The first operated image frame is rotated along the rotation direction for 270 degrees to generate a second rotated image frame. The second rotated image frame is stored in the frame storage circuit. The second rotated image frame is read row-by-row to the operation storage circuit. A second row direction image operation is performed on the second rotated image frame row-by-row to generate a second operated image frame. The second operated image frame is outputted.

The present invention further discloses an image processing method having a storage resource saving mechanism that includes steps outlined below. An original image frame is stored in a frame storage circuit. The original image frame is read row-by-row to an operation storage circuit. A first row direction image operation is performed on the original image frame row-by-row to generate a first operated image frame to be stored in the operation storage circuit. The first operated image frame is rotated along a rotation direction for 90 degrees to generate a first rotated image frame. The first rotated image frame is stored to the frame storage circuit. The first rotated image frame is read row-by-row to the operation storage circuit. A second row direction image operation is performed on the first rotated image frame row-by-row to generate a second operated image frame to be stored in the operation storage circuit. The second operated image frame is rotated along the rotation direction for 270 degrees to generate a second rotated image frame. The second rotated image frame is outputted.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of an image processing apparatus having a storage resource saving mechanism according to an embodiment of the present invention.

FIG. 2 illustrates a flow chart of an image processing method having a storage resource saving mechanism according to an embodiment of the present invention.

FIG. 3 illustrates a diagram of a plurality of image frames related to the image processing performed by the image processing apparatus according to an embodiment of the present invention.

FIG. 4 illustrates a diagram of a sliding window according to an embodiment of the present invention.

FIG. 5 illustrates a block diagram of an image processing apparatus having a storage resource saving mechanism according to an embodiment of the present invention.

FIG. 6 illustrates a flow chart of an image processing method having the storage resource saving mechanism according to an embodiment of the present invention.

FIG. 7 illustrates a flow chart of an image processing method having a storage resource saving mechanism according to an embodiment of the present invention.

FIG. 8 illustrates a diagram of a plurality of image frames related to the image processing performed by the image processing apparatus according to an embodiment of the present invention.

### DETAILED DESCRIPTION OF THE PREFERRED EMBODIMENTS

An aspect of the present invention is to provide an image processing apparatus and an image processing apparatus method having a storage resource saving mechanism to perform operation on pixels in a cross pattern by using two stages of image rotations and row-direction image operations to accomplish the object of the decreasing of the hardware cost and the efficiency of image processing.

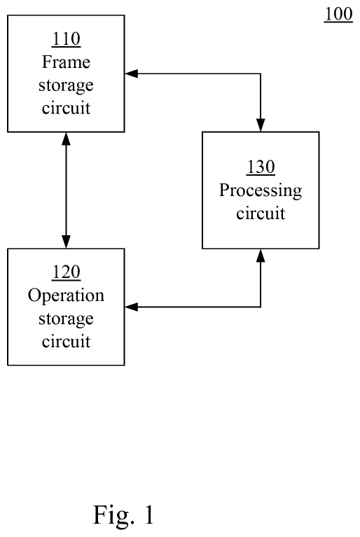

Reference is now made to FIG. 1. FIG. 1 illustrates a block diagram of an image processing apparatus 100 having a storage resource saving mechanism according to an embodiment of the present invention. The image processing apparatus 100 includes a frame storage circuit 110, an operation storage circuit 120 and a processing circuit 130.

Each of the frame storage circuit 110 and the operation storage circuit 120 can be any circuit capable of storing data. In an embodiment, the frame storage circuit 110 is a dynamic random-access memory (DRAM). The operation storage circuit 120 is a static random-access memory (SRAM) or a register.

The processing circuit 130 is electrically coupled to the frame storage circuit 110 and the operation storage circuit 120, and is configured to execute the computer executable commands (not illustrated) stored therein, in which the computer executable commands include such as, but not limited to the firmware/driver and related commands of the frame storage circuit 110, the operation storage circuit 120 and other hardware modules in the image processing apparatus 100. By executing the computer executable commands, the processing circuit 130 can access the signals and/or data of the frame storage circuit 110 and the operation storage circuit 120 to perform operation accordingly to execute the function of the image processing apparatus 100.

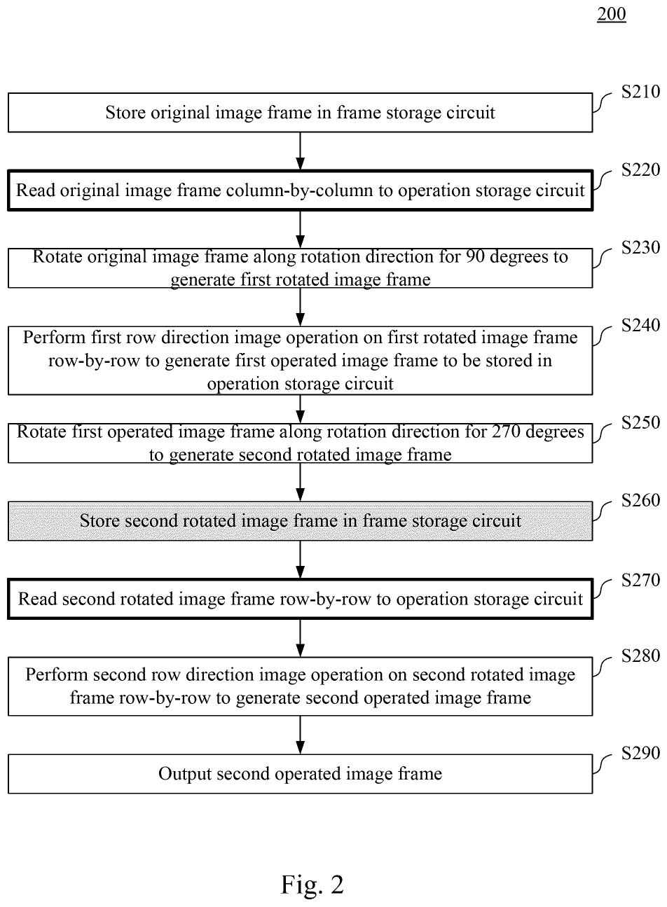

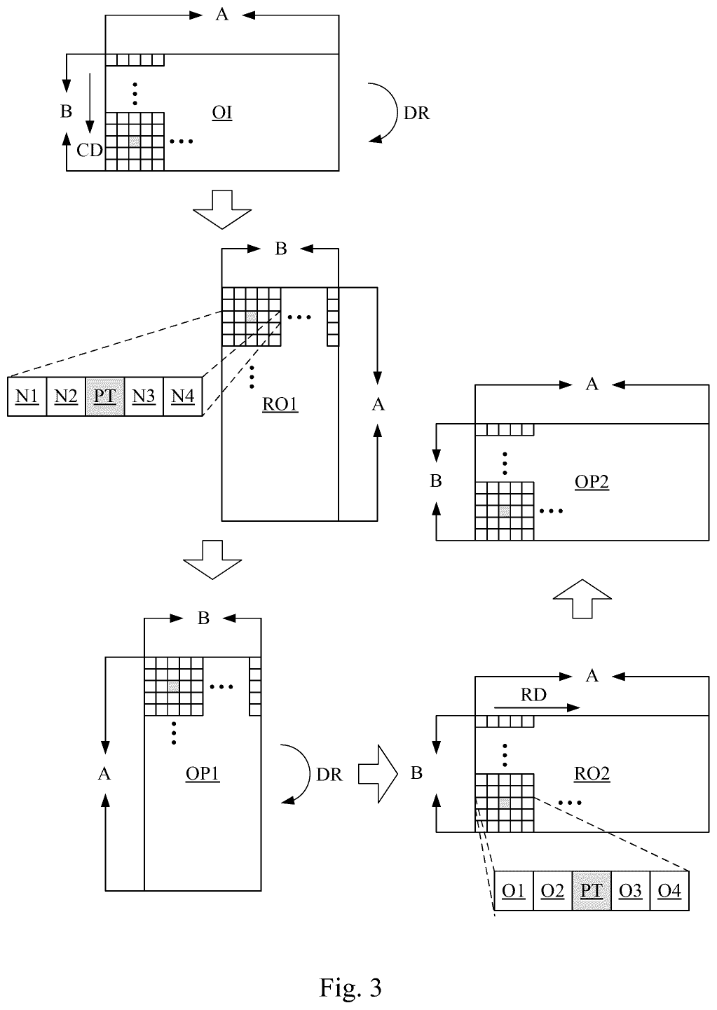

The operation of the image processing apparatus 100 in FIG. 1 is described in detail in accompany with FIG. 2 and FIG. 3.

Reference is now made to FIG. 2 and FIG. 3. FIG. 2 illustrates a flow chart of an image processing method 200 having a storage resource saving mechanism according to an embodiment of the present invention. FIG. 3 illustrates a diagram of a plurality of image frames related to the image processing performed by the image processing apparatus 100 according to an embodiment of the present invention.

Besides the apparatus described above, the present invention further discloses the image processing method 200 having the storage resource saving mechanism that can be used in such as, but not limited to the image processing apparatus 100 illustrated in FIG. 1. An embodiment of the image processing method 200 is illustrated in FIG. 2 and includes the steps outlined below.

In step S210, an original image frame OI is stored in the frame storage circuit 110 by the processing circuit 130.

In an embodiment, the original image frame OI can be received by the image processing apparatus 100 through such as, but not limited to a network, and can be stored in the frame storage circuit 110 after a decoding performed thereon. In another embodiment, the original image frame OI can be stored in the image processing apparatus 100 in advance. The present invention is not limited to a specific source of the original image frame OI.

As illustrated in FIG. 3, the original image frame OI includes a plurality of original pixels arranged to be an array having a row number and a column number, wherein the column number is larger than the row number. In other words, the original image frame OI can be an image frame having A columns and B rows to have size of A×B, in which A is preferably larger than B.

In step S220, the original image frame OI is read column-by-column to the operation storage circuit 120 by the processing circuit 130.

As illustrated in FIG. 3, corresponding to the column direction CD, the processing circuit 130 reads the original image frame OI column-by-column. In the example described above, since the size of the original image frame OI is A×B, the processing circuit 130 reads the original image frame OI from the first column to the A-th column.

In step S230, the original image frame OI is rotated along a rotation direction DR for 90 degrees to generate a first rotated image frame RO1 by the processing circuit 130.

In an embodiment, each column of pixels of the original image frame OI read by the processing circuit 130 is stored as a row of the pixels of the first rotated image frame RO1 to accomplish the rotation mechanism. As illustrated in FIG. 3, the original image frame OI having the size of A×B becomes the first rotated image frame RO1 having the size of B×A after the 90-degree rotation.

In step S240, a first row direction image operation is performed on the first rotated image frame RO1 row-by-row to generate a first operated image frame OP1 to be stored in the operation storage circuit 120 by the processing circuit 130.

In an embodiment, the first row direction image operation performed by the processing circuit 130 is to perform a pixel averaging operation or a pixel interpolation operation on a target pixel and a plurality of neighboring pixels within a neighboring range in the same row of the target pixel in the first rotated image frame RO1.

Take a target pixel PT in the first rotated image frame RO1 as an example, the processing circuit 130 performs an operation on the target pixel PT and the neighboring pixels N1˜N4 within a range of two pixels on the right side and two pixels on the left side, in which the pixel values of these five pixels are averaged or interpolated to generate the final pixel value of the target pixel PT after the first row direction image operation is performed. For the pixels at the edges of the first rotated image frame RO1 (e.g., the pixels at the beginning position and the ending position of a row of pixels), the neighboring pixels do not exist. However, the method of such as, but not limited to setting redundant pixels having default pixel values can be used to perform the operation. The present invention is not limited to a specific operation method.

As a result, after the same operation is performed on all the pixels in the first rotated image frame RO1 by the processing circuit 130, all the final pixel values generated accordingly are the pixel values of the pixels in the first operated image frame OP1. As illustrated in FIG. 3, since each of the pixels in the first rotated image frame RO1 are operated by the processing circuit 130 to generate the first operated image frame OP1, the size of the first operated image frame OP1 is still B×A.

In step S250, the first operated image frame OP1 is rotated along the rotation direction DR for 270 degrees to generate a second rotated image frame RO2 by the processing circuit 130.

In an embodiment, after the operation on a row of pixels of the first operated image frame OP1 is finished being performed, the processing circuit 130 stores such a row of pixels as a column of pixels of the second rotated image frame RO2 to accomplish the rotation mechanism. As illustrated in FIG. 3, the first operated image frame OP1 having the size of B×A is rotated to generate the second rotated image frame RO2 having the size of A×B.

It is appreciated that the first rotated image frame RO1 is generated by rotating the original image frame OI for 90 degrees along the rotation direction DR, and the first operated image frame OP1 is generated from the first rotated image frame RO1. As a result, the pixels of the second rotated image frame RO2 generated by rotating the first operated image frame OP1 for 270 degrees along the rotation direction DR correspond to the pixels of the original image frame OI.

In step S260, the second rotated image frame RO2 is stored in the frame storage circuit 110 by the processing circuit 130.

In an embodiment, the second rotated image frame RO2 and the original image frame OI are stored in two independent areas of the frame storage circuit 110 such that the data of the second rotated image frame RO2 does not replace the data of the original image frame OI.

In step S270, the second rotated image frame RO2 is read row-by-row to the operation storage circuit 120 by the processing circuit 130.

As illustrated in FIG. 3, corresponding to the row direction RD, the processing circuit 130 reads the second rotated image frame RO2 row-by-row. In the example described above, since the size of the second rotated image frame RO2 is A×B, the processing circuit 130 reads the second rotated image frame RO2 from the first row to the B-th row.

In step S280, a second row direction image operation is performed on a second rotated image frame RO2 row-by-row to generate a second operated image frame OP2 by the processing circuit 130.

In an embodiment, similar to the first row direction image operation, the second row direction image operation performed by the processing circuit 130 is to perform a pixel averaging operation or a pixel interpolation operation on a target pixel and a plurality of neighboring pixels within a neighboring range in the same row of the target pixel in the second rotated image frame RO2.

Take the target pixel PT also in the second rotated image frame RO2 as an example, the processing circuit 130 performs operation on the target pixel PT and the neighboring pixels O1˜O4 within a range of two pixels on the right side and two pixels on the left side, in which the pixel values of these five pixels are averaged or interpolated to generate the final pixel value of the target pixel PT after the second row direction image operation is performed. For the pixels at the edges of the second rotated image frame RO2 (e.g., the pixels at the beginning position and the ending position of a row of pixels), the neighboring pixels do not exist. However, the method of such as, but not limited to setting redundant pixels having default pixel values can be used to perform operation. The present invention is not limited to a specific operation method.

As a result, after the same operation is performed on all the pixels in the second rotated image frame RO2 by the processing circuit 130, all the final pixel values generated accordingly are the pixel values of the pixels in the second operated image frame OP2. As illustrated in FIG. 3, since each of the pixels in the second rotated image frame RO2 are operated by the processing circuit 130 to generate the second operated image frame OP2, the size of the second operated image frame OP2 is still A×B.

In step S290, the second operated image frame OP2 is outputted by the processing circuit 130.

In FIG. 2, the steps related to reading on the frame storage circuit 110 performed by the processing circuit 130 (e.g., steps S220 and S270) are illustrated with thick frames. The steps related to writing to the frame storage circuit 110 performed by the processing circuit 130 (e.g., step 260) is illustrated with the frame filled with gray color. As a result, two reading and one writing of the frame storage circuit 110 are performed in the image processing method 200.

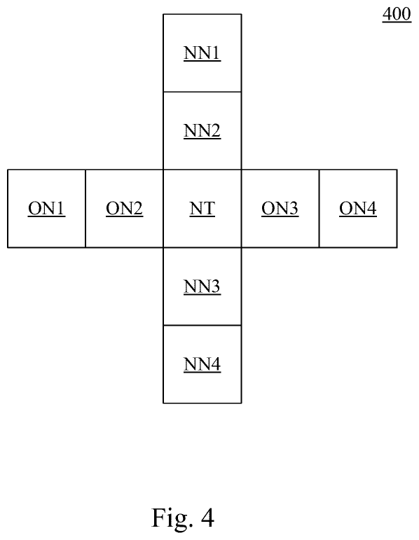

Reference is now made to FIG. 4. FIG. 4 illustrates a diagram of a sliding window 400 according to an embodiment of the present invention. The sliding window 400 includes the pixels NT, NN1˜NN4 and ON1˜ON4 arranged to be a cross shape.

In an embodiment, the operation including the first rotation, the first row direction image operation, the second rotation and the second row direction image operation performed on the original image frame OI described in FIG. 2 is equivalent to the operation performed on each of the pixels of the original image frame OI by using the sliding window 400 in FIG. 4.

Take the embodiment in FIG. 3 as an example, when the center pixel NT of the sliding window 400 corresponds to the target pixel PT, the pixels NN1˜NN4 in the range of two pixels at the upside of the center pixel NT and two pixels at the downside of the center pixel NT (which is along the vertical direction) corresponds to the neighboring pixels N1˜N4 used in the first row direction image operation since the first rotated image frame RO1 is the 90-degree rotation result of the original image frame OI. The pixels ON1˜ON4 in the range of two pixels at the left side of the center pixel NT and two pixels at the right side of the center pixel NT (which is along the vertical direction) corresponds to the neighboring pixels O1˜O4 used in the second row direction image operation since the pixels of second rotated image frame RO2 correspond to the pixels of the original image frame OI.

In the field of image processing, the debanding operation or the filtering operation may use the operation performed on the pixels in a range of a cross pattern. As a result, in an embodiment, the first row direction image operation and the second row direction image operation in the method described above can be used to perform the debanding operation or the filtering operation on the original image frame OI.

In some approaches, the operation on the pixels in the range of the cross pattern is performed by reading a plurality of rows of pixels of the original image frame OI and directly performing operation of the pixels on the target pixel and the four sides of neighboring pixels. Such a method avoids multiple reading and writing performed on frame storage circuit. However, a static random-access memory with a large amount of line buffers is required to store the multiple rows of pixels such that the storage cost increases. The example of the cross pattern having only two pixels in the four directions around the center pixel is used in the above embodiment. However, in practical application, more pixels in the four directions around the center pixel may be referred to accomplish a better operation result such that the storage cost increases even further.

In comparison, the image processing apparatus in the present invention performs operation on pixels in a cross pattern by using two stages of image rotations and row-direction image operations to accomplish the object of the decreasing of the hardware cost and the efficiency of image processing without storing the pixels on the vertical direction by using a large amount of line buffers. The trade-off between hardware cost and operation efficiency can be avoided.

In some systems, a pre-processing is performed on the image frame stored in the frame storage circuit such that the subsequent image processing is further performed. The two image rotations and the first row direction image operation in the present invention are equivalent to performing the pre-processing on the image. As a result, no additional read and write on the frame storage circuit is actually presented in such a system.

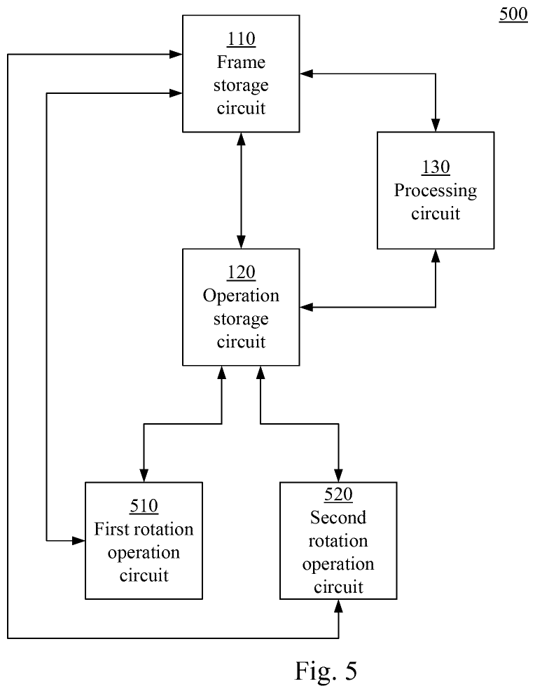

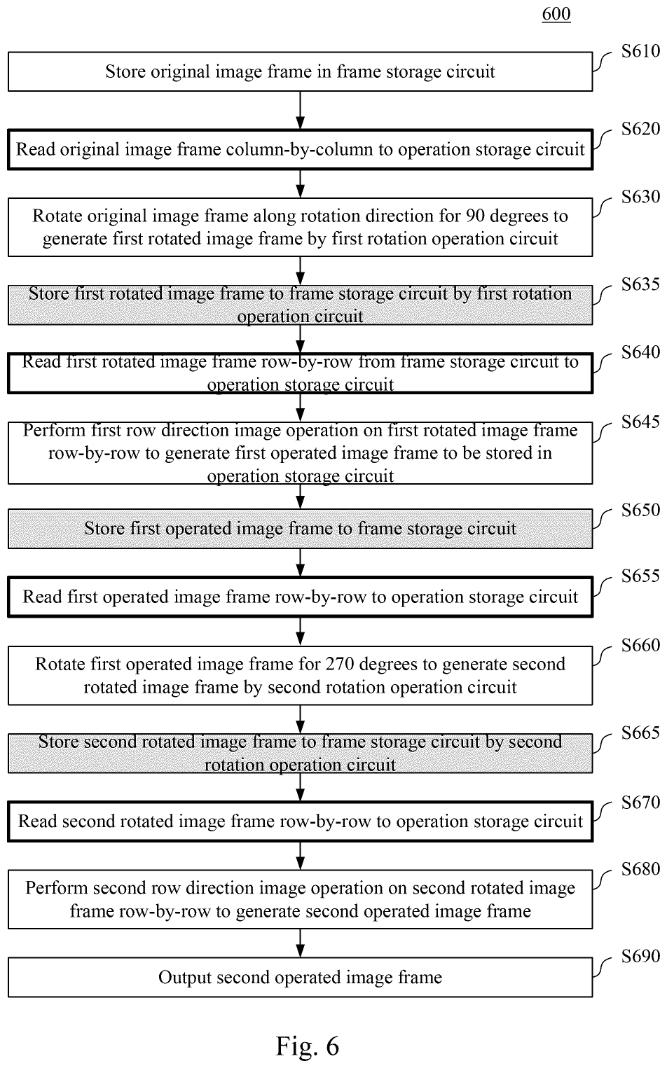

Reference is now made to FIG. 5 and FIG. 6 at the same time. FIG. 5 illustrates a block diagram of an image processing apparatus 500 having a storage resource saving mechanism according to an embodiment of the present invention. FIG. 6 illustrates a flow chart of an image processing method 600 having the storage resource saving mechanism according to an embodiment of the present invention.

The image processing apparatus 500 in FIG. 5 is similar to the image processing apparatus 100 in FIG. 1 and includes the frame storage circuit 110, the operation storage circuit 120 and the processing circuit 130. The identical components are not further described herein. In the present embodiment, the image processing apparatus 500 in FIG. 5 further includes a first rotation operation circuit 510 and a second rotation operation circuit 520.

Besides the apparatus described above, the present invention further discloses the image processing method 600 having the storage resource saving mechanism that can be used in such as, but not limited to the image processing apparatus 500 illustrated in FIG. 5. An embodiment of the image processing method 600 is illustrated in FIG. 6 and includes the steps outlined below.

In the present embodiment, the steps S610 and S620 are identical to the steps S210 and S220 in FIG. 2 and the detail thereof is not described thereof.

In step S630, the original image frame OI is rotated for 90 degrees to generate the first rotated image frame RO1 by the first rotation operation circuit 510 independent from the processing circuit 130.

In step S635, the first rotated image frame RO1 is stored to the frame storage circuit 110 by the first rotation operation circuit 510.

In step S640, the first rotated image frame RO1 is read row-by-row from the frame storage circuit 110 to the operation storage circuit 120 by the processing circuit 130.

In step S645, the first row direction image operation is performed on the first rotated image frame RO1 row-by-row by the processing circuit 130 to generate the first operated image frame OP1 to be stored in the operation storage circuit 120.

In step S650, the first operated image frame OP1 is stored to the frame storage circuit 110 by the processing circuit 130.

In step S655, the first operated image frame OP1 is read row-by-row to the operation storage circuit 120 by the processing circuit 130.

In step S660, the first operated image frame OP1 is rotated for 270 degrees to generate the second rotated image frame RO2 by a second rotation operation circuit 520 independent from the processing circuit 130.

In step S665, the second rotated image frame RO is stored to the frame storage circuit 110 by the second rotation operation circuit 520.

In the present embodiment, the steps S670 to S690 are identical to the steps S270 to S290 in FIG. 2 and the detail thereof is not described thereof.

In an embodiment, the original image frame OI, the first rotated image frame RO1, the first operated image frame OP1 and the second rotated image frame RO2 are stored in four independent areas of the frame storage circuit 110 and the data stored in each of these areas is not replaced by other data.

In FIG. 6, the steps related to reading on the frame storage circuit 110 performed by the processing circuit 130 (e.g., steps S620, S640, S655 and S670) are illustrated with thick frames. The steps related to writing to the frame storage circuit 110 performed by the processing circuit 130 (e.g., steps S635, S650 and S665) are illustrated with the frames filled with gray color. As a result, four reading and three writing of the frame storage circuit 110 are performed in the image processing method 500.

By using the method described above, the image processing apparatus 500 in FIG. 5 uses the first rotation operation circuit 510 and the second rotation operation circuit 520 independent from the processing circuit 130 to perform 90-degree rotation and 270-degree rotation respectively. Such a configuration increases the number of reading and writing on the frame storage circuit 110 performed by the processing circuit 130. However, the usage of the operation storage circuit 120 decreases such that the storage cost thereof decreases as well.

It is appreciated that in some embodiments, the image processing apparatus may only include one of the first rotation operation circuit 510 and the second rotation operation circuit 520 such that a balance between the number of reading and writing on the frame storage circuit 110 and the usage of the operation storage circuit 120 can be maintained. The present invention is not limited to a specific configuration.

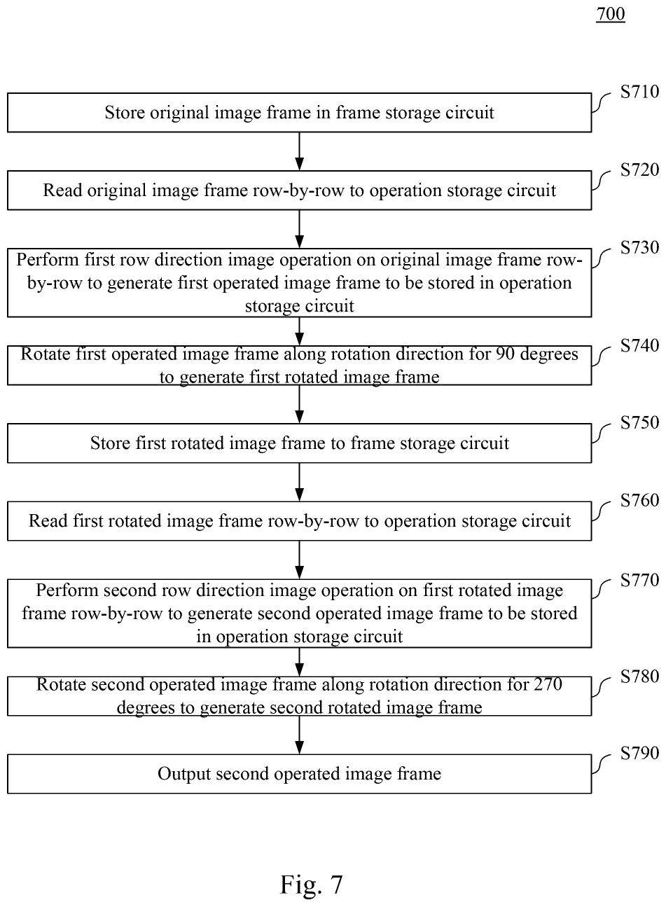

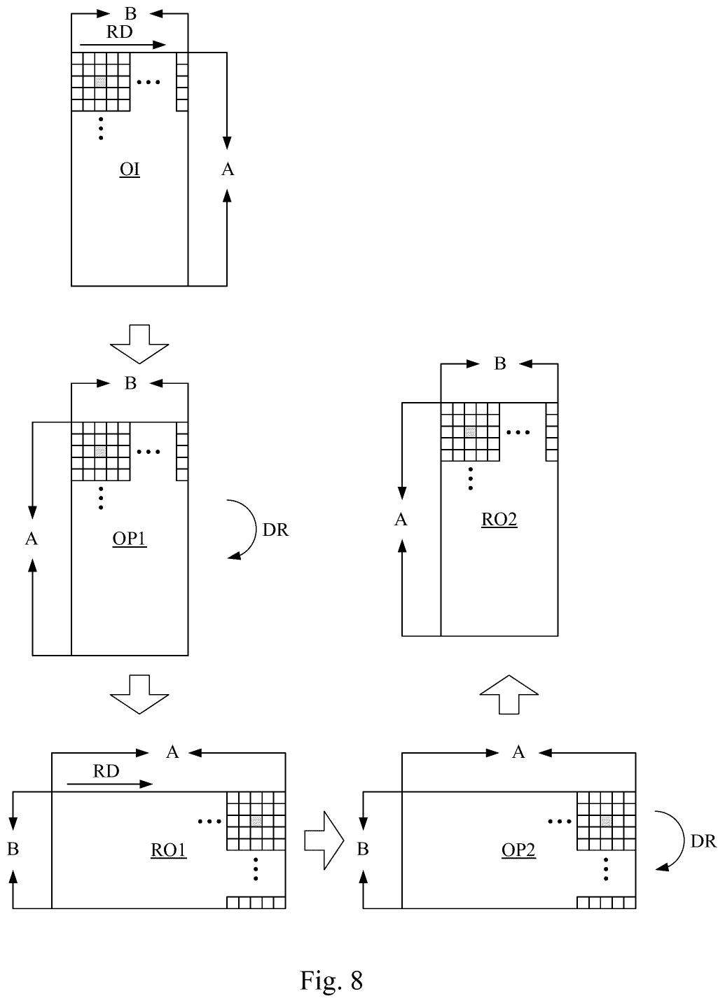

Reference is now made to FIG. 7 and FIG. 8 at the same time. FIG. 7 illustrates a flow chart of an image processing method 700 having a storage resource saving mechanism according to an embodiment of the present invention. FIG. 8 illustrates a diagram of a plurality of image frames related to the image processing performed by the image processing apparatus 100 according to an embodiment of the present invention.

Besides the apparatus described above, the present invention further discloses the image processing method 700 having the storage resource saving mechanism that can be used in such as, but not limited to the image processing apparatus 100 illustrated in FIG. 1. An embodiment of the image processing method 700 is illustrated in FIG. 7 and includes the steps outlined below.

In step S710, the original image frame OI is stored in the frame storage circuit 110 by the processing circuit 130.

As illustrated in FIG. 8, in the present embodiment, the original image frame OI includes a plurality of original pixels arranged to be an array having a row number and a column number, wherein the row number is larger than the column number. In other words, the original image frame OI can be an image frame having A rows and B columns to have size of B×A, in which A is larger than B.

In step S720, the original image frame OI is read row-by-row to the operation storage circuit 120 by the processing circuit 130.

As illustrated in FIG. 8, corresponding to the row direction RD, the processing circuit 130 reads the original image frame OI row-by-row. In the example described above, since the size of the original image frame OI is B×A, the processing circuit 130 reads the original image frame OI from the first row to the B-th row.

In step S730, the first row direction image operation is performed on the original image frame OI row-by-row to generate the first operated image frame OP1 to be stored in the operation storage circuit 120 by the processing circuit 130. The performance of the first row direction image operation is identical to that described in the previous embodiment and is not described herein. Since each of the pixels in the original image frame OI are operated by the processing circuit 130 to generate the first operated image frame OP1, the size of the first operated image frame OP1 is still B×A.

In step S740, the first operated image frame OP1 is rotated along the rotation direction DR for 90 degrees to generate the first rotated image frame RO1 by the processing circuit 130. As illustrated in FIG. 8, the first operated image frame OP1 having the size of B×A is rotated to generate the first rotated image frame RO1 having the size of A×B.

In step S750, the first rotated image frame RO1 is stored to the frame storage circuit 110 by the processing circuit 130.

In step S760, the first rotated image frame RO1 is read row-by-row to the operation storage circuit 120 by the processing circuit 130.

As illustrated in FIG. 8, corresponding to the row direction RD, the processing circuit 130 reads the first rotated image frame RO1 row-by-row. In the example described above, since the size of the first rotated image frame RO1 is A×B, the processing circuit 130 reads the first rotated image frame RO1 from the first row to the B-th row.

In step S770, the second row direction image operation is performed on the first rotated image frame RO1 row-by-row to generate the second operated image frame OP2 to be stored in the operation storage circuit 120 by the processing circuit 130. The performance of the second row direction image operation is identical to that described in the previous embodiment and is not described herein. Since each of the pixels in the first rotated image frame RO1 are operated by the processing circuit 130 to generate the second operated image frame OP2, the size of the second operated image frame OP2 is still A×B.

In step S780, the second operated image frame OP2 is rotated along the rotation direction DR for 270 degrees to generate the second rotated image frame RO2 by the processing circuit 130. As illustrated in FIG. 8, the second operated image frame OP2 having the size of A×B is rotated for 270 degrees to generate the second rotated image frame RO2 having the size of B×A.

In step S790, the second rotated image frame RO2 is outputted by the processing circuit 130.

As a result, the image processing apparatus may select the order of the image rotations and the row direction image operations elastically according to the size of the original image frame. The present invention is not limited to a specific order to perform the image rotations and the row direction image operations.

It is appreciated that the embodiments described above are merely an example. In other embodiments, it is appreciated that many modifications and changes may be made by those of ordinary skill in the art without departing, from the spirit of the invention. For example, the numbers of the neighboring pixels involved in the first row direction image operation and the second row direction image operation can be the same or different. Further, the image rotation of the image frame can be all in the clockwise direction or all in the counter clockwise direction.

In summary, the image processing apparatus and the image processing apparatus method having the storage resource saving mechanism perform operation on pixels in a cross pattern by using two stages of image rotations and row-direction image operations to accomplish the object of the decreasing of the hardware cost and the efficiency of image processing.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. An image processing method having a storage resource saving mechanism, comprising:
storing an original image frame in a frame storage circuit;
reading the original image frame column-by-column to an operation storage circuit;
rotating the original image frame along a rotation direction for 90 degrees to generate a first rotated image frame;
performing a first row direction image operation on the first rotated image frame row-by-row to generate a first operated image frame to be stored in the operation storage circuit;
rotating the first operated image frame along the rotation direction for 270 degrees to generate a second rotated image frame;
storing the second rotated image frame in the frame storage circuit;
reading the second rotated image frame row-by-row to the operation storage circuit;
performing a second row direction image operation on the second rotated image frame row-by-row to generate a second operated image frame; and
outputting the second operated image frame.

2. The image processing method of claim 1, wherein the frame storage circuit is a dynamic random-access memory (DRAM) and the operation storage circuit is a static random-access memory (SRAM) or a register.

3. The image processing method of claim 1, wherein the first row direction image operation and the second row direction image operation are configured to perform a debanding operation or a filtering operation, and the first row direction image operation and the second row direction image operation respectively perform a pixel averaging operation or a pixel interpolation operation on a target pixel and a plurality of neighboring pixels within a neighboring range in the same row of the target pixel.

4. The image processing method of claim 1, further comprising:
rotating the original image frame for 90 degrees to generate the first rotated image frame by a first rotation operation circuit.

5. The image processing method of claim 4, further comprising:
storing the first rotated image frame to the frame storage circuit; and
reading the first rotated image frame row-by-row from the frame storage circuit to perform the first row direction image operation.

6. The image processing method of claim 1, further comprising:
rotating the first operated image frame for 270 degrees to generate the second rotated image frame by the second rotation operation circuit.

7. The image processing method of claim 6, further comprising:
storing the first operated image frame to the frame storage circuit; and
reading the first operated image frame from the frame storage circuit so as to be rotated for 270 degrees by the second rotation operation circuit.

8. The image processing method of claim 1, wherein the original image frame comprises a plurality of original pixels arranged to be an array having a row number and a column number, wherein the column number is larger than the row number.

9. An image processing apparatus having a storage resource saving mechanism, comprising:
a frame storage circuit;
an operation storage circuit; and
a processing circuit electrically coupled to the frame storage circuit and the operation storage circuit and configured to execute an image processing method comprising:
storing an original image frame in the frame storage circuit;
reading the original image frame column-by-column to the operation storage circuit;
rotating the original image frame along a rotation direction for 90 degrees to generate a first rotated image frame;
performing a first row direction image operation on the first rotated image frame row-by-row to generate a first operated image frame to be stored in the operation storage circuit;
rotating the first operated image frame along the rotation direction for 270 degrees to generate a second rotated image frame;
storing the second rotated image frame in the frame storage circuit;
reading the second rotated image frame column-by-column to the operation storage circuit;
performing a second row direction image operation on the second rotated image frame row-by-row to generate a second operated image frame; and
outputting the second operated image frame.

10. The image processing apparatus of claim 9, wherein the frame storage circuit is a dynamic random-access memory and the operation storage circuit is a static random-access memory or a register.

11. The image processing apparatus of claim 9, wherein the first row direction image operation and the second row direction image operation are configured to perform a debanding operation or a filtering operation, and the first row direction image operation and the second row direction image operation respectively perform a pixel averaging operation or a pixel interpolation operation on a target pixel and a plurality of neighboring pixels within a neighboring range in the same row of the target pixel.

12. The image processing apparatus of claim 9, wherein the image processing method further comprises:
rotating the original image frame for 90 degrees to generate the first rotated image frame by a first rotation operation circuit.

13. The image processing apparatus of claim 12, wherein the image processing method further comprises:
storing the first rotated image frame to the frame storage circuit; and
reading the first rotated image frame row-by-row from the frame storage circuit to perform the first row direction image operation.

14. The image processing apparatus of claim 9, wherein the image processing method further comprises:
rotating the first operated image frame for 270 degrees to generate the second rotated image frame by the second rotation operation circuit.

15. The image processing apparatus of claim 14, wherein the image processing method further comprises:
storing the first operated image frame to the frame storage circuit; and
reading the first operated image frame from the frame storage circuit so as to be rotated for 270 degrees by the second rotation operation circuit.

16. The image processing apparatus of claim 9, wherein the original image frame comprises a plurality of original pixels arranged to be an array having a row number and a column number, wherein the column number is larger than the row number.

17. An image processing method having a storage resource saving mechanism, comprising:
storing an original image frame in a frame storage circuit;
reading the original image frame row-by-row to an operation storage circuit;
performing a first row direction image operation on the original image frame row-by-row to generate a first operated image frame to be stored in the operation storage circuit;
rotating the first operated image frame along a rotation direction for 90 degrees to generate a first rotated image frame;
storing the first rotated image frame to the frame storage circuit;
reading the first rotated image frame row-by-row to the operation storage circuit;
performing a second row direction image operation on the first rotated image frame row-by-row to generate a second operated image frame to be stored in the operation storage circuit;
rotating the second operated image frame along the rotation direction for 270 degrees to generate a second rotated image frame; and
outputting the second rotated image frame.

18. The image processing method of claim 17, wherein the original image frame comprises a plurality of original pixels arranged to be an array having a row number and a column number, wherein the row number is larger than the column number.
